(19) United States
(12) Patent Application Publication
(10) Pub. No.: US 2016/0109100 A1
(43) Pub. Date: Apr. 21, 2016

(54) LIGHTING APPARATUS

(71) Applicant: SAMSUNG ELECTRONICS CO., LTD., Suwon-si (KR)

(72) Inventor: Sun Ki KIM, Suwon-si (KR)

(21) Appl. No.: 14/794,575

(22) Filed: Jul. 8, 2015

(30) Foreign Application Priority Data
Oct. 21, 2014 (KR) 10-2014-0142736

(51) Int. Cl. F21V 14/00; F21V 3/04; F21V 23/04; F21V 7/04; F21V 14/04

(52) U.S. Cl. CPC F21V 14/003; F21V 7/04; F21V 14/04; F21V 23/0471; F21V 3/049; F21Y 2101/025

(57) ABSTRACT

A lighting apparatus comprises a light source module outputting light, a reflective module comprising a plurality of optical systems, each of which having a plurality of variable thickness elements, each of which having a thickness adjustable according to a thickness control signal, and a mirror disposed on the plurality of variable thickness elements and reflecting the light output from the light source module, and a controller configured to generate the thickness control signal to independently control the thicknesses of the plurality of variable thickness elements and determine a reflection direction of each of the plurality of optical systems.

### CROSS-REFERENCE TO RELATED APPLICATION

This application claims priority to Korean Patent Application No. 10-2014-0142736 filed on Oct. 21, 2014, with the Korean Intellectual Property Office, the entirety of which is incorporated herein by reference.

### TECHNICAL FIELD

The present disclosure relates to a lighting apparatus.

### BACKGROUND

Recently, demand has increased for lighting apparatuses allowing for the adjustment of a light distribution direction. For example, demand has increased for intelligent lighting apparatuses for applications such as in the headlamps of vehicles, in streetlamps, in indoor lighting fixtures, and the like, that may irradiate light in a particular direction or that may not irradiate light in a particular direction. In order to realize these objectives, researchers have proposed schemes of moving light sources or turning a portion of light sources on and off, but such existing schemes may put strain on light sources, and thus, research into a new scheme is required.

### SUMMARY

An aspect of the present disclosure may provide a lighting apparatus capable of easily controlling a light distribution direction.

According to an aspect of the present disclosure, a lighting apparatus may include: a light source module outputting light, a reflective module including a plurality of optical systems each of which having a plurality of variable thickness elements, each of which having a thickness adjustable according to a thickness control signal, and a mirror disposed on the plurality of variable thickness elements and configured to reflect the light output from the light source module, and a controller configured to generate the thickness control signal to independently control the thicknesses of the plurality of variable thickness elements and determine a reflection direction of each of the plurality of optical systems.

Each of the plurality of optical systems may include a single mirror, and the single mirror may be supported by the plurality of variable thickness elements.

Reflection directions of the plurality of optical systems may be a direction corresponding to differences in the thicknesses of each optical system's plurality of variable thickness elements.

The light source module may include a laser light source.

The lighting apparatus may further include a light emitting module configured to diffuse the light output from the laser light source and reflected from the plurality of optical systems and to emit the diffused light outwardly.

The controller may be configured to determine a distribution of light emitted outwardly from the light emitting module by determining the reflection direction of each of the plurality of optical systems.

The lighting apparatus may further include a sensor configured to sense at least one of an external object and an external light source and to generate a sensing signal, wherein the controller is configured to determine the distribution of light emitted outwardly from the light emitting module according to the sensing signal.

The controller may be configured to determine the reflection direction of each of the plurality of optical systems such that the light emitted outwardly from the light emitting module has at least two main light distribution directions.

The sensing signal may include information regarding a region in which at least one of the external object and the external light source is sensed, and the controller may be configured to determine the reflection direction of each of the plurality of optical systems such that the light is not irradiated to the sensed region or such that light is irradiated to the sensed region.

The light source module may include a plurality of laser light sources outputting light having different colors.

The light source module may include a light collecting module configured to collect the light having different colors and to generate white light.

The light source module may include an expander disposed between the light collecting module and the reflective module.

The light source module may include a collimator disposed between the expander and the reflective module.

According to another aspect of the present disclosure, a lighting apparatus may include: a light source module including a laser light source, a reflective module including a plurality of optical systems each having a mirror configured to reflect light output from the light source module to a light emitting module, a light emitting module configured to diffuse the light reflected from the plurality of optical systems and to emit diffused light outwardly, and a controller configured to determine a reflection direction of each of the plurality of optical systems and to determine a distribution of the light emitted from the light emitting module.

The variable thickness element may include a piezoelectric element.

The variable thickness element may include a voice coil motor.

The light source module may include a reflector disposed between the collimator and the reflective module.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view schematically illustrating a lighting apparatus according to an exemplary embodiment in the present disclosure;

FIG. 2 is a top view of a reflective module employed in the lighting apparatus according to the exemplary embodiment of FIG. 1;

FIGS. 3A and 3B are views illustrating optical systems according to the exemplary embodiment of FIG. 1;

FIGS. 4A through 4C are views illustrating an operation of the optical system according to the exemplary embodiment of FIG. 1;

FIGS. 5A and 5B are views specifically illustrating a light source module illustrated in FIG. 1;

FIGS. 6A through 6D are views illustrating an operation of the lighting apparatus illustrated in FIG. 1;

FIGS. 7 through 9 are top views illustrating reflective modules according to a modified exemplary embodiment of FIG. 1;

FIG. 10 is a view schematically illustrating a lighting apparatus according to an exemplary embodiment in the present disclosure;

FIG. 11 is a view illustrating a state in which a lighting apparatus according to an exemplary embodiment in the present disclosure is applied to a headlamp;

FIG. 12 is a view illustrating a state in which a lighting apparatus according to an exemplary embodiment in the present disclosure is applied to a streetlamp; and

FIG. 13 is a view illustrating a state in which a lighting apparatus according to an exemplary embodiment in the present disclosure is applied to an indoor lighting fixture.

### DETAILED DESCRIPTION

Various embodiments will now be described more fully with reference to the accompanying drawings in which multiple embodiments are shown. The present disclosure may, however, be embodied in different forms and should not be construed as limited to the embodiments set forth herein. Rather, these embodiments are provided so that this disclosure is thorough and complete and fully conveys the present disclosure to those skilled in the art. In the drawings, the sizes and relative sizes of layers and regions may be exaggerated for clarity.

It will be understood that when an element or layer is referred to as being “on,” “connected to,” or “coupled to” another element or layer, it can be directly on, connected, or coupled to the other element or layer or intervening elements or layers may be present. In contrast, when an element is referred to as being “directly on,” “directly connected to,” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosure.

Spatially relative terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, when an embodiment can be implemented differently, functions or operations described in a particular block may occur in a different way from a flow described in the flowchart. For example, two consecutive blocks may be performed simultaneously, or the blocks may be performed in reverse according to related functions or operations.

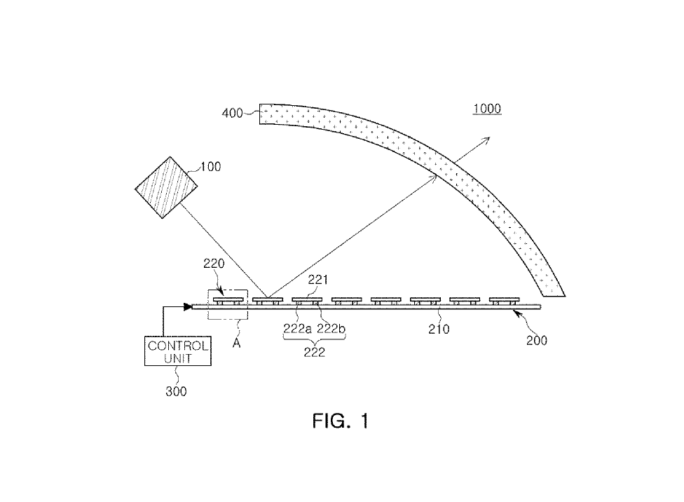

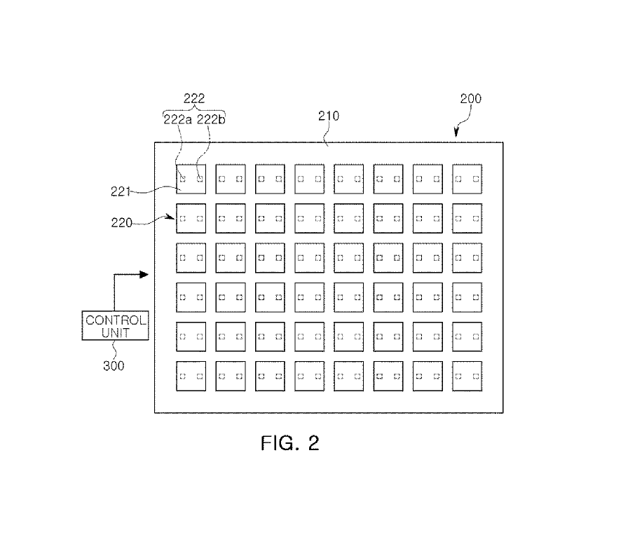

FIG. 1 is a view schematically illustrating a lighting apparatus 1000 according to an exemplary embodiment in the present disclosure. FIG. 2 is a top view of a reflective module 200 employed in the lighting apparatus 1000 according to the exemplary embodiment of FIG. 1.

Referring to FIG. 1, the lighting apparatus 1000 according to an embodiment in the present disclosure includes the reflective module 200 having a plurality of optical systems 220 reflecting light output from the light source module 100 and a controller 300 determining a reflection direction of the plurality of optical systems 220. The lighting apparatus 1000 may further include a light emitting module 400 diffusing light reflected from the plurality of optical systems 220 to outwardly emit diffused light.

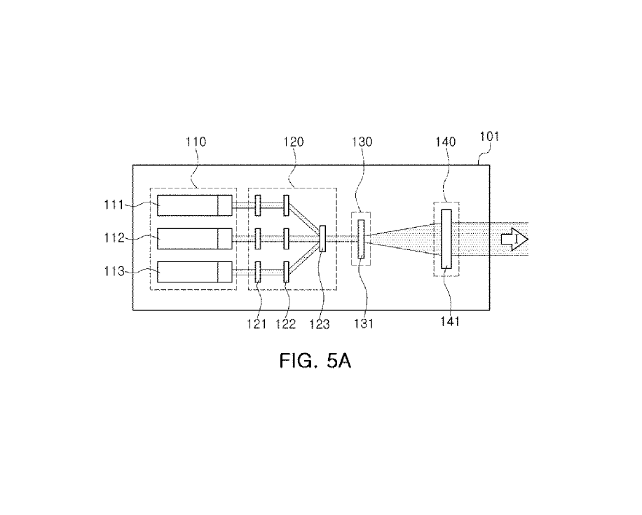

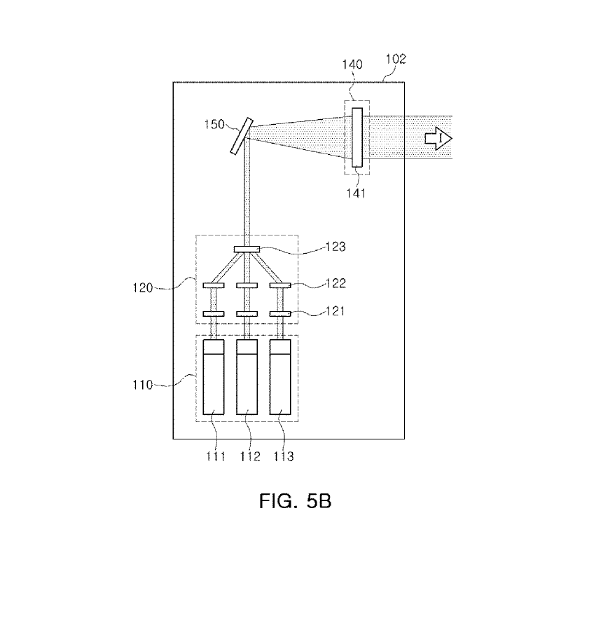

Light output from the light source module 100, rather than being directly transmitted through the light emitting module 400 and outwardly emitted, may be changed in terms of a direction of travel thereof by the reflective module 200 and outwardly emitted through the light emitting module 400. The light source module 100 may include a semiconductor light emitting device. Also, light output from the light source module 100 may be high intensity light. The light source module 100 will hereinafter be described in detail with reference to FIGS. 5A and 5B.

In one embodiment in the present disclosure, the reflective module 200 may include a plurality of optical systems 220. In detail, referring to FIG. 2 together with FIG. 1, the reflective module 200 may include a board 210 and a plurality of optical systems 220 disposed on the board 210. The plurality of optical systems 220 may be disposed in rows and columns on the board 210. In FIG. 2, it is illustrated that a plurality of optical systems 220 are arranged in six rows and eight columns, but the number of rows and columns may be variously modified as needed.

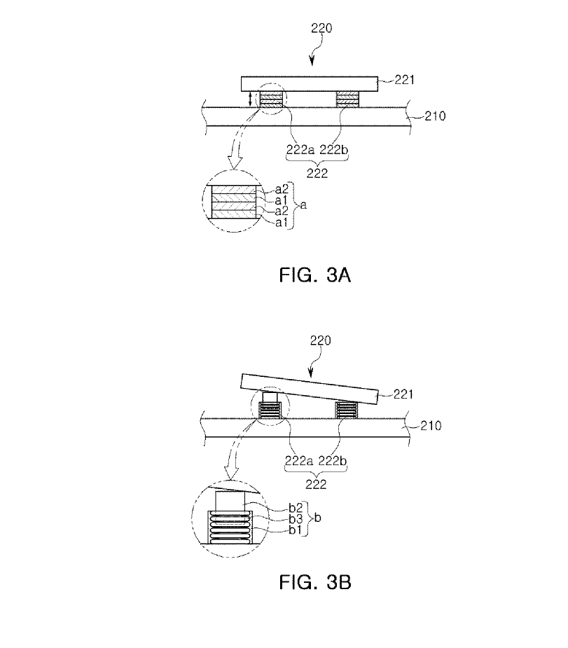

FIGS. 3A and 3B are views illustrating the optical system 220 according to an exemplary embodiment in the present disclosure. Specifically, FIGS. 3A and 3B are enlarged cross-sectional views of region ‘A’ of FIG. 1. Referring to FIGS. 3A and 3B, each of the plurality of optical systems 220 may include a plurality of variable thickness elements 222 (for example, first and second variable thickness elements 222a and 222b) disposed on the board 210 of the reflective module 200 and a mirror 221 disposed on the plurality of variable thickness elements 222. Each of the plurality of optical systems 220 may include a mirror 221. In other words, in a single optical system 220, the mirror 221 and the variable thickness elements 222 may be in a 1:n relationship, where n is an integer equal to or greater than 2.

The mirror 221 may have a reflective surface reflecting light output from the light source module 100, and the reflective surface may be provided as a flat surface.

The plurality of variable thickness elements 222 may be changed in thickness according to thickness control signals.

As illustrated in FIG. 3A, the variable thickness element 222 may include a piezoelectric element (a), for example. The piezoelectric element (a) has characteristics in that when a voltage is applied thereto, mechanical stress is exerted, to increase the thickness thereof. Thus, in the lighting apparatus 1000 according to an embodiment in the present disclosure, the piezoelectric element (a) may be employed as the variable thickness element 222. In one example, a thickness control signal may be a voltage. Although not limited thereto, the piezoelectric element (a) may be a multilayer piezoelectric element including a structure in which a plurality of piezoelectric layers a1 and a2, having different polarization directions, are stacked in order to exhibit sufficient thickness deformation.

Also, as illustrated in FIG. 3B, the variable thickness element 222 may include a voice coil motor (b). The voice coil motor (b) may include a case b1 and a magnet b2 and a coil b3 provided within the case b1. The voice coil motor (b) may be disposed such that the coil b3 covers the magnet b2 or the magnet b2 covers the coil. When a current flows in the coil b3, electromagnetic attractive force or repulsive force may be exerted in a relationship with force from the magnet b2, and thus, the coil b3 and the magnet b2 may move relatively with respect to each other. For example, as illustrated in FIG. 3B, the magnet b2 may move in an upward direction, increasing the thickness of the voice coil motor (b). In this case, a thickness control signal may be a current applied to the coil b3. However, without being limited thereto, the coil b3 may move in the upward direction to increase the thickness of the voice coil motor (b).

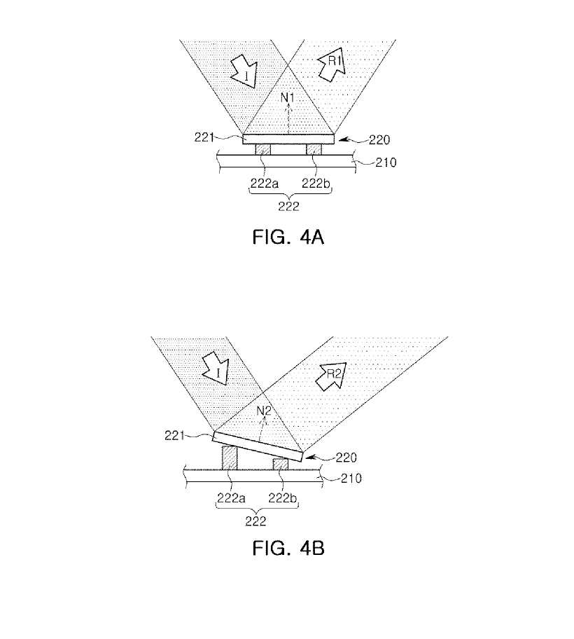

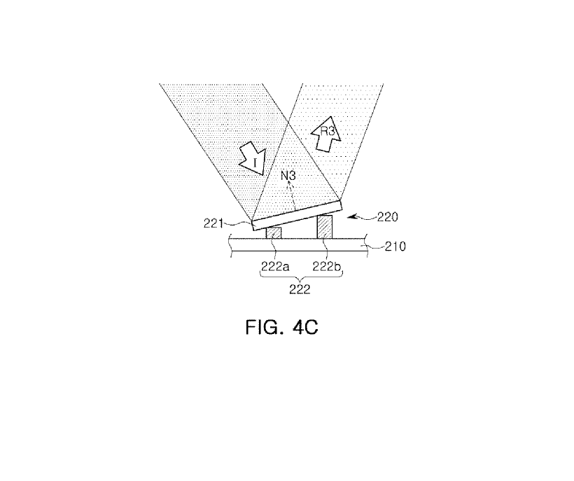

The plurality of variable thickness elements 222 may be disposed between the mirror 221 and the board 210 to change a direction in which a reflective surface of the mirror 211 is oriented, according to differences in thickness. This will be described with reference to FIGS. 4A through 4C.

In detail, as illustrated in FIG. 4A, when thicknesses of the first and second variable thickness elements 222a and 222b have the same thickness (no difference in thickness), a direction N1 in which the reflective surface of the mirror 221 faces may be perpendicular to the board 210. Thus, the optical system 220 may reflect light output from the light source module 100 in a first reflection direction R1. Also, as illustrated in FIGS. 4B and 4C, when the thickness of the first variable thickness element 222a increases to be greater than that of the second variable thickness element 222b or when the thickness of the second variable thickness element 222b increases to be greater than that of the first variable thickness element 222b, directions N2 and N3 in which the reflective surface of the mirror 221 faces are changed, and thus the optical system 220 may reflect light output from the light source module 100 in second and third reflection directions R2 and R3, respectively. The thicknesses of the first and second variable thickness elements 222a and 222b may be controlled by the controller 300. Meanwhile, in order to allow the directions in which the reflective surface of the mirror 221 faces to be easily changed even with a relatively small change in thicknesses of the plurality of variable thickness elements 222, the plurality of variable thickness elements 222 may be disposed to be adjacent to the edges of the rear surface of the reflective surface. Also, it is illustrated that the mirror 221 is disposed on two variable thickness elements 222a and 222b, but the amount of variable thickness elements may be varied as needed.

Referring back to FIGS. 1 and 2, the lighting apparatus 1000 according to an embodiment in the present disclosure may include a controller 300 configured to determine the thicknesses of the variable thickness elements 222. The controller 300 may generate a thickness control signal and transmit the generated thickness control signal to the plurality of variable thickness elements 222, respectively. Although not limited thereto, the thickness control signals may be transmitted to the variable thickness elements 222 through wiring patterns formed on the board 210 of the reflective module 200.

The controller 300 may independently control the thicknesses of the plurality of variable thickness elements 222, and accordingly, the directions N1, N2, and N3 in which the reflective surface of the mirror 221 faces provided in each of the plurality of optical systems 220 may be changed and reflection directions R1, R2, and R3 of each of the plurality of optical systems 220 may be determined. As described above, the light reflected from the plurality of optical systems 220 may be transmitted through the light emitting module 400 so as to be outwardly emitted, and here, when the reflection directions of the plurality of optical systems 220 are changed, a distribution of light outwardly emitted through the light emitting module 400 is varied, and thus it may be understood that the controller 300 is configured to determine a distribution of light emitted outwardly from the light emitting module 400.

In one embodiment in the present disclosure, the light source module 100 may output light having straightness. On the basis of the straightness of the light, a traveling direction of light reflected from each of the plurality of optical systems 220 and moving toward the light emitting module 400 may be precisely controlled. Although not limited thereto, the light source module 100 may include a laser light source in order to output light having excellent straightness. In this case, the light source module 100 may effectively generate light less irregularly reflected (scattered-reflected) and traveling in an intended reflection direction. Laser light output from the light source module 100 may be, for example, white light that may be used as illumination light. In general, laser light has such a narrow irradiation diameter as to be applied as is to illumination light, and thus, the light emitting module 400 may diffuse light reflected from the plurality of optical systems 220 to allow diffused light to be emitted outwardly.

FIGS. 5A and 5B are views specifically illustrating the light source module 100 illustrated in FIG. 1.

Referring to FIG. 5A, a light source module 101 according to an embodiment in the present disclosure may include a light source unit 110 and a light collecting module 120. The light source unit 110 may include a plurality of laser light sources 111, 112, and 113, and the plurality of laser light sources 111, 112, and 113 may output light having different colors, respectively. For example, as illustrated, the first to third laser light sources 111, 112, and 113 may output blue light, red light, and green light, respectively, and the laser light having different colors may be mixed in the light collecting module 120 to generate white light.

Although not limited thereto, the light collecting module 120 may include a second light collecting lens 122 collecting light output from the light source unit 110. White light is generated from the different-colored lights that are collected to a point and may travel in one direction through a third light collecting lens 123. A first light collecting lens 121 that provides straightness may be disposed between the light source unit 110 and the second light collecting lens 122, allowing light output from the laser light sources 111, 112, and 113 to reach the second light collecting lens 122.

In an exemplary embodiment, the light source module 101 may include an expander 130 disposed between the light collecting module 120 and the reflective module 200. The expander 130 may increase an irradiation diameter of light output to the reflective module 200, and may include, for example, an expander lens 131. Also, a collimator 140 may be disposed between the expander 130 and the reflective module 200. The collimator 140 may provide straightness to the light output from the expander 130. The collimator 140 may include, for example, a collimating lens 141. Thus, light emitted from the light source module 101 may be uniformly irradiated to the reflective module 200.

Also, as illustrated in FIG. 5B, a light source module 102 may include a reflector 150 disposed between the light collecting module 120 and the reflective module 200. The reflector 150 may change a direction of white light output from the light collecting module 120 to a different direction, for example, by 90 degrees. When laser light is reflected by the reflector 150, an irradiation diameter may increase to a degree, and the reflector 150 may have the same function as that of the expander 130 described above with reference to FIG. 5A. The collimator 140 is disposed on a path of light reflected from the reflector 150 and output to the reflective module 200, providing straightness to the light reflected from the reflector 150. Thus, light emitted from the light source module 102 has straightness so as to be uniformly irradiated to the reflective module 200.

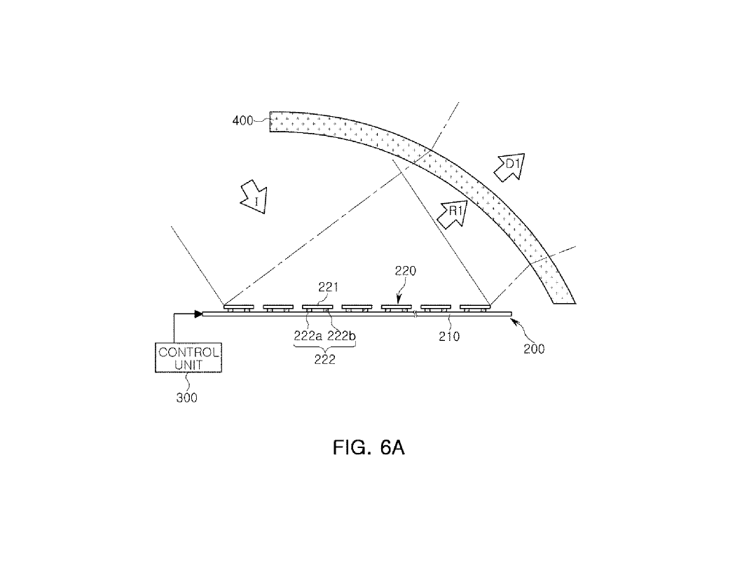

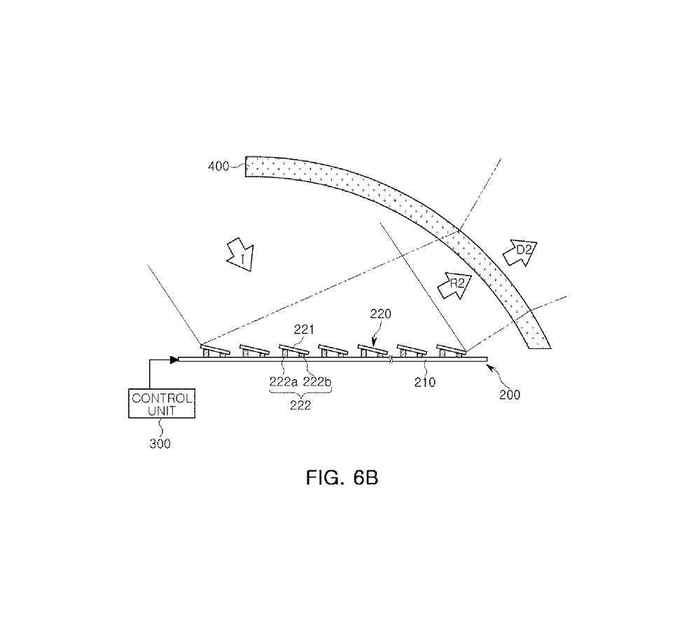

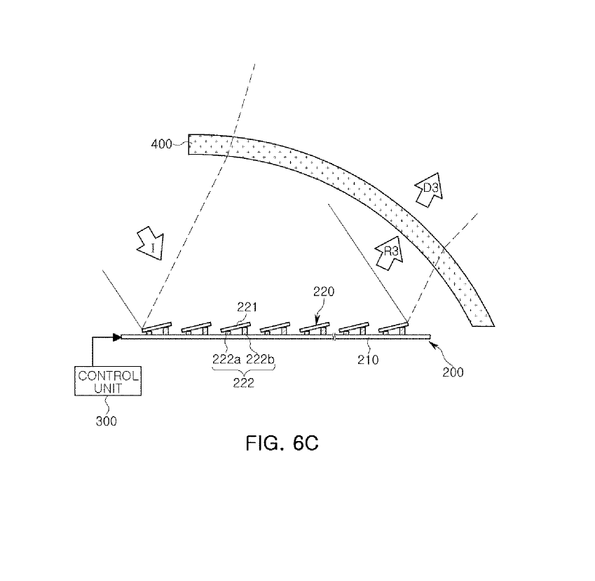

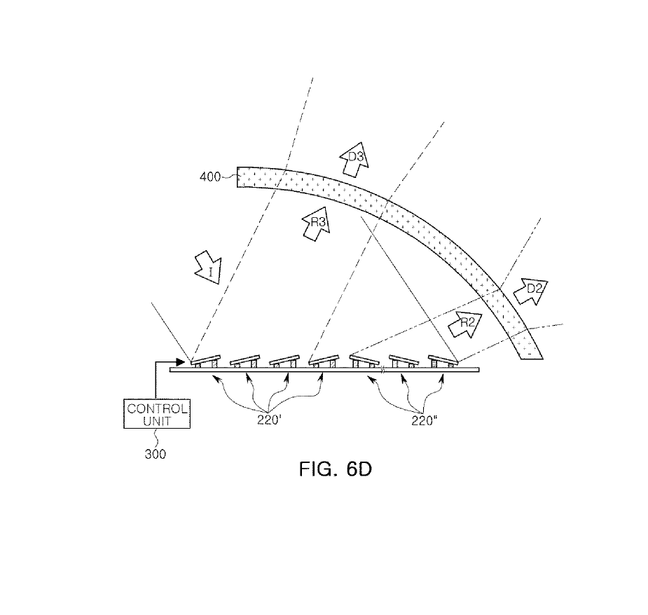

Hereinafter, the operation of the lighting apparatus 1000 according to the exemplary embodiment of FIG. 1 will be described in detail with reference to FIGS. 6A through 6D. For the purpose of clarification and convenience, the light source module 100 is omitted in FIGS. 6A through 6D.

As illustrated in FIG. 6A, the controller 300 may be configured to determine both the first and second variable thickness elements 222a and 222b provided in the plurality of optical systems 220 to have the same thickness. Accordingly, a degree to which the plurality of optical systems 220 are angled is determined by a value with which light output from the light source module 100 travels along the first reflection direction R1. Thus, light output from the light source module 100 may be reflected from the plurality of optical systems 220 and incident to the light emitting module 400 in a first incident direction, and light transmitted through the light emitting module 400 so as to be outwardly emitted may have a first light distribution direction D1 as a main light distribution direction.

Here, as illustrated in FIG. 6B, the controller 300 may increase the thickness of the first variable thickness elements 222a among the plurality of variable thickness elements 222 provided in each of the plurality of optical systems 220. Thus, a degree to which each of the plurality of optical systems 220 is angled may be determined by a value with which light output from the light source module 100 travels in the second reflection direction R2. Thus, the light output from the light source module 100 may be reflected to the plurality of optical systems 220 and incident to the light emitting module 400 in a second incident direction. In this case, a main light distribution direction of light transmitted through the light emitting module 400 and emitted outwardly may be changed from a first light distribution direction D1 to a second distribution direction D2.

Alternatively, as illustrated in FIG. 6C, the controller 300 may increase the thickness of the second variable thickness elements 222b and the plurality of optical systems 220 may be angled to allow light output from the light source module 100 to be reflected in a third reflection direction R3. Light output from the light source module 100 is incident to the light emitting module 400 in a third incident direction. Accordingly, a main light distribution direction of light transmitted through the light emitting module 400 and emitted outwardly may be a third light distribution direction D3.

In the three cases mentioned above, an irradiation direction I of light output from the light source module 100 and travelling to the reflective module 200 on which the plurality of optical systems 220 may be uniform. Namely, according to the embodiment in the present disclosure, without separately controlling a position and an operation of the light source module 100, the lighting apparatus 1000 may emit light in a desired light distribution direction.

The controller 300 may determine a reflection direction of a portion of the plurality of optical systems 220 to be different from that of another portion of the plurality of optical systems 220. In this case, light emitted outwardly from the light emitting module 400 may have at least two main light distribution directions according to a control operation of the controller 300. For example, as illustrated in FIG. 6D, the second variable thickness elements 222b of some optical systems 220′, among the plurality of optical systems 220, may have an increased thickness, and the first variable thickness elements 222a of the other optical systems 220″ may have an increased thickness. In this case, light reflected from the plurality of optical systems 220 may be incident to the light emitting module 400 in at least two main incident directions, and light emitted outwardly from the light emitting module 400 may have at least two main light distribution directions (for example, the third light distribution direction D3 and the second light distribution direction D2). Based on this scheme, the lighting apparatus 1000 may serve not to allow light to be irradiated to a particular region according to circumstances.

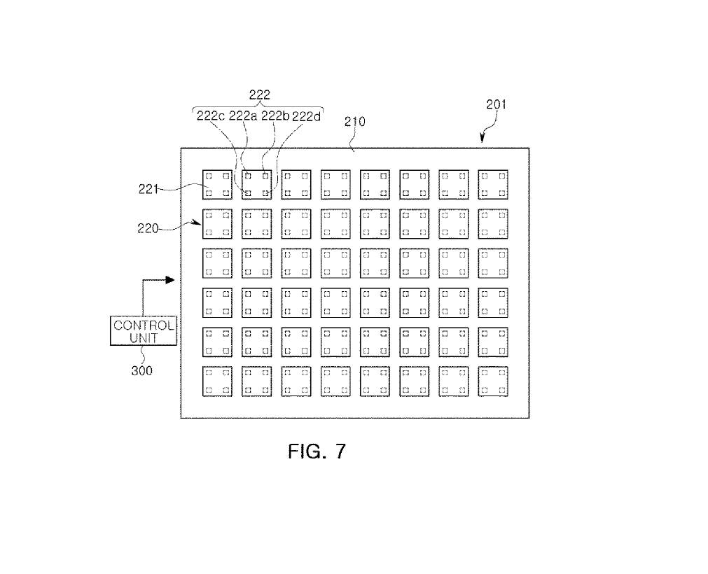

FIGS. 7 through 9 are top views illustrating reflective modules 201, 202, and 203 according to a modified exemplary embodiment of FIG. 1;

Referring to FIG. 7, the reflective module 201 may include a board 210 and a plurality of optical systems 220 disposed on the board 210. Unlike the previous exemplary embodiment, mirrors 221 provided in the plurality of optical systems 220 are disposed on four variable thickness elements 222 (hereinafter, referred to as “first to fourth variable thickness elements 222a, 222b, 222c, and 222d”). As illustrated, the variable thickness elements 222 may be disposed to be adjacent to vertices (corners) of a rear surface of a reflective surface of each mirror 221. In this case, each of the plurality of optical systems 220 may be determined to have nine reflection directions due to differences in thicknesses of the first to fourth variable thickness elements 222a, 222b, 222c, and 222d. For example, each of the plurality of optical systems 220 may be determined to have nine reflection directions overall, according to a case in which thicknesses of all the variable thickness elements are the same, a case in which a thickness of any one among the first to fourth variable thickness elements 222a, 222b, 222c, and 222d is relatively large, a case in which thicknesses of any two among the first to fourth variable thickness elements 222a, 222b, 222c, and 222d are relatively large, specifically, a case in which the thicknesses of the first and second variable thickness elements 222a and 222b are relatively larger than those of the other variable thickness elements 222c and 222d, a case in which thicknesses of the third and fourth variable thickness elements 222c and 222d are relatively large, a case in which the thicknesses of the first and third variable thickness elements 222a and 222c are relatively large, and the thicknesses of the second and fourth variable thickness elements 222b and 222d are relatively large.

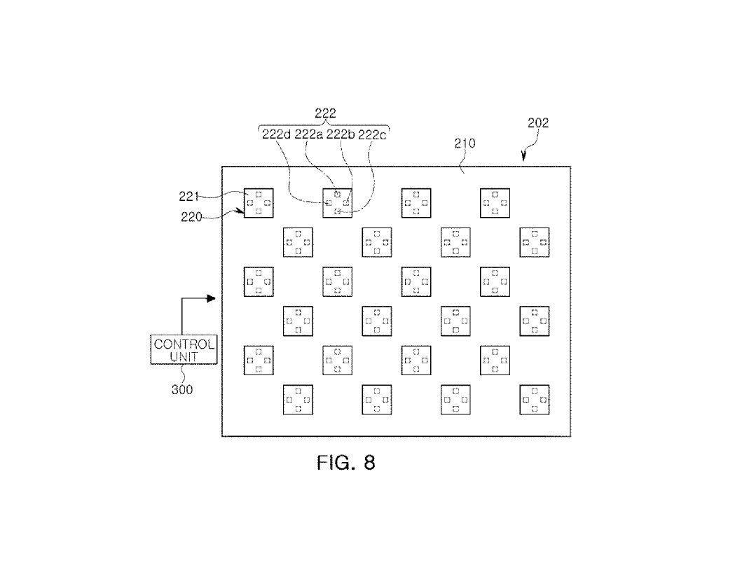

Meanwhile, in the reflective module 202 illustrated in FIG. 8, a plurality of optical systems 220 may be disposed in a zigzag manner on the board 210. Also, unlike those of the reflective module 201 described above with reference to FIG. 7, the first to fourth variable thickness elements 222a, 222b, 222c, and 222d may be disposed to be adjacent to the centers of edges of a rear surface of a reflective surface of each mirror 221.

In this case, each of the plurality of optical systems 220 may be determined to have nine reflection directions due to differences in the thicknesses of the first to fourth variable thickness elements 222a, 222b, 222c, and 222d. In detail, each of the plurality of optical systems 220 may be determined to have nine reflection directions overall, according to a case in which the thicknesses of all the variable thickness elements are not increased (no difference in thickness), a case in which a thickness of any one among the first to fourth variable thickness elements 222a, 222b, 222c, and 222d is increased, a case in which the thicknesses of the first and second variable thickness elements 222a and 222b are increased, a case in which the thicknesses of the third and fourth variable thickness elements 222c and 222d are increased, a case in which the thicknesses of the first and fourth variable thickness elements 222a and 222d are increased, and the thicknesses of the second and third variable thickness elements 222b and 222c are increased.

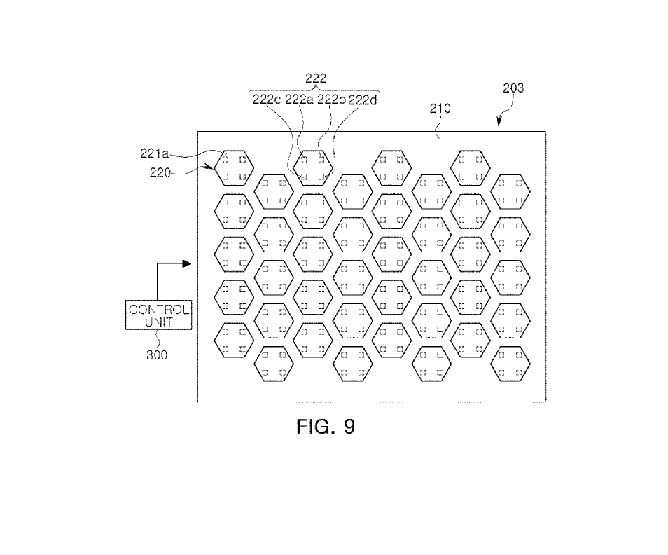

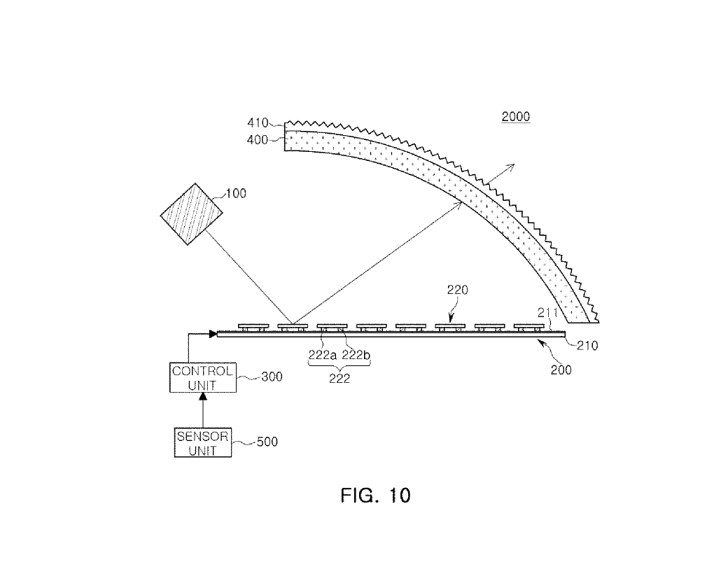

The shape of the reflective surface of each mirror 221 provided in the plurality of optical systems 220 may be variously modified. For example, like the reflective module 203 illustrated in FIG. 9, the reflective surface of each mirror 221a may have a hexagonal shape. The mirror 222a provided in a single optical system 220 may be disposed such that corners thereof are adjacent to the mirror 221a provided in the other optical system 220, forming a honeycomb structure. In this case, mounting density of the plurality of optical systems 220 may be improved and a light distribution direction of light emitted outwardly from the light emitting module 400 may be effectively controlled.

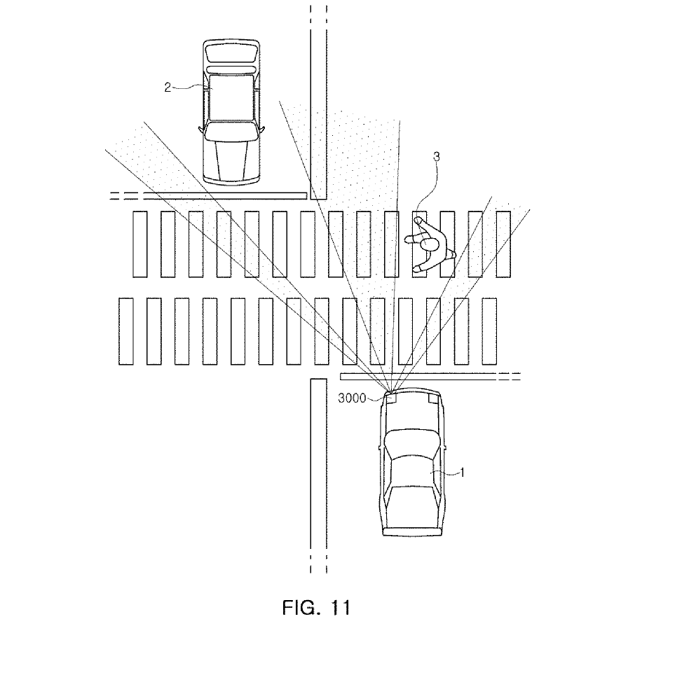

FIG. 10 is a view schematically illustrating a lighting apparatus 2000 according to an exemplary embodiment in the present disclosure. Hereinafter, descriptions of matters that may be applied in the same manner as those described above in the previous exemplary embodiment will be omitted and differences between embodiments will be largely described.

In one embodiment in the present disclosure, a reflective module 200 may include a board 210 on which a plurality of optical systems 220 are disposed, and the board 210 may include a reflective surface 211 formed on one surface thereof on which the plurality of optical systems 220 are disposed. A partial amount of light output from the light source module 100 may be reflected from the reflective surface 211 of the board 210 and travel to the light emitting module 400. In this case, the lighting apparatus 2000 may emit both light whose light distribution direction is controlled by the controller 300 and light reflected from the reflective surface 211 of the board 210 and having an unchanged light distribution direction, irrespective of a control operation of the controller 300, together.

The light emitting module 400 may include a light diffusing unit 410. The light diffusing unit 410 may have an incident surface to which light reflected from the plurality of optical systems 220 is incident and an output surface from which incident light is emitted outwardly. A depression and protrusion pattern may be formed on the output surface to guarantee an effective light diffusing function.

In the embodiment in the present disclosure, the lighting apparatus 2000 may include a sensor 500 sensing at least one of an external object and an external light source and generating a sensing signal. The controller 300 may control a light distribution direction of light emitted outwardly from the light emitting module 400. This will be described in detail with reference to FIGS. 11 through 13 hereinafter.

FIG. 11 is a view illustrating a state in which a lighting apparatus according to an exemplary embodiment in the present disclosure is applied to a headlamp 3000.

Referring to FIG. 11 together with FIG. 10, the sensor 500 may be disposed in an appropriate position to sense an object positioned outside of a vehicle 1 in which it is positioned and an external light source.

The sensor 500 may generate a sensing signal including information regarding a region in which at least one of the external object and the external light source is sensed. Here, the controller 300 may determine a reflection direction of each of the plurality of optical systems 220 such that light may not be irradiated to the sensed region. Accordingly, the headlamp 3000 employing the lighting apparatus according to the embodiment in the present disclosure may not interfere with a visual field of a driver of a counterpart vehicle 2 or a visual field of a pedestrian 3 who crosses the street at a crosswalk or a road, while securing a maximum visual field from the vehicle 1 in which it is positioned. In addition to the sensing signal, the controller 300 may determine a reflection direction of each of the plurality of optical systems 220 according to a driving operation such as a left turn or a right turn of the vehicle 1 in which it is positioned. For example, when the vehicle 1 in which it is positioned turns to the left, the controller 300 may determine a reflection direction of each of the plurality of optical systems 220 such that the left region in which a relatively large visual field is required to be secured may become brighter.

According to an embodiment in the present disclosure, unlike the scheme in which light sources are partially turned on and off in order to irradiate light or in order not to irradiate in a particular direction, the light source module 100 may be maintained in an ON state, and thus, the headlamp 3000 whose light distribution direction is appropriately controlled without putting strain on the operation of the light source module 100 may be obtained.

In particular, unlike a general lighting apparatus, the headlamp 3000 needs to transmit light to some distance to secure a visual field for the driver of the vehicle 1. In an embodiment in the present disclosure, since laser light is used as a light source and the laser light is diffused by the light emitting module 400 so as to be utilized as lighting, a more appropriate visual field may be secured.

The sensor 500 may include at least one among a position sensor and a light receiving sensor in order to sense a location of the counterpart vehicle 2 and/or the pedestrian 3. The light receiving sensor may use a scheme of sensing a location of the counterpart vehicle 2 by sensing light emitted from a headlamp of the counterpart vehicle 2.

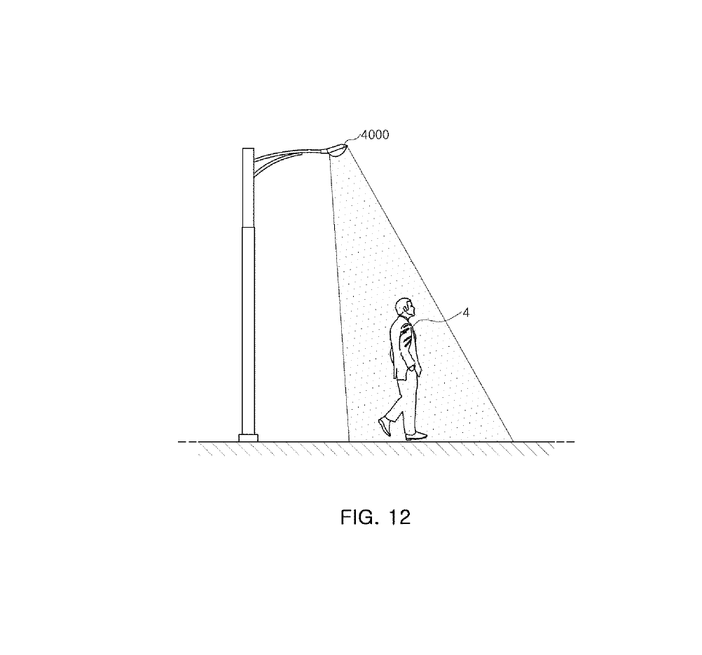

FIG. 12 is a view illustrating a state in which a lighting apparatus according to an exemplary embodiment in the present disclosure is applied to a streetlamp 4000.

Referring to FIG. 12 together with FIG. 10, the sensor 500 may be disposed in an appropriate position to sense an object present (on the road) outside of the illumination of the streetlamp 4000. In an embodiment in the present disclosure, the sensor 500 may sense a change in a position of an object present outside (of the illumination of the streetlamp 4000), and generate a sensing signal including information regarding a region in which the external object has been sensed. Here, the controller 300 may determine a reflection direction of each of the plurality of optical systems 220 such that light may be irradiated to the sensed region. Thus, the streetlamp 4000 employing the lighting apparatus according to the embodiment in the present disclosure may sense a person 4 who walks on the road and, as a consequence, collectively brighten the region in which the person 4 is present.

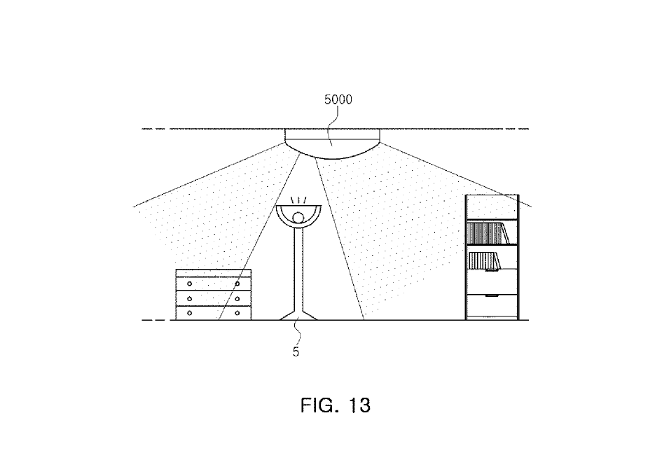

FIG. 13 is a view illustrating a state in which a lighting apparatus according to an exemplary embodiment in the present disclosure is applied to an indoor lamp (indoor lighting fixture) 5000.

Referring to FIG. 13 together with FIG. 10, although not limited thereto, the indoor lamp 5000 may be installed on the ceiling, and the sensor 500 may sense a light source outside of the indoor lamp 5000 and generate a sensing signal including information regarding the sensed region. The controller 300 may determine a reflection direction of each of the plurality of optical systems 220 such that light may not be irradiated to the sensed region. Thus, the indoor lamp 5000 may not irradiate light to a region in which an electric bulb 5 is installed, and the like, in the indoor area, and instead may be used to brighten a darker area.

As set forth above, according to exemplary embodiments of the present disclosure, the lighting apparatus capable of easily controlling a light distribution direction may be obtained.

While exemplary embodiments have been shown and described above, it will be apparent to those skilled in the art that modifications and variations could be made without departing from the scope of the present inventive concept as defined by the appended claims.

What is claimed is:

1. A lighting apparatus comprising:
a light source module outputting light;
a reflective module comprising a plurality of optical systems, each of which has a plurality of variable thickness elements, each having a thickness adjustable according to a thickness control signal, and a mirror disposed on the plurality of variable thickness elements and reflecting the light output from the light source module; and
a controller configured to generate the thickness control signal to independently control the thicknesses of the plurality of variable thickness elements and determine a reflection direction of each of the plurality of optical systems.

2. The lighting apparatus of claim 1, wherein each of the plurality of optical systems comprises a single mirror, and the single mirror is supported by the plurality of variable thickness elements.

3. The lighting apparatus of claim 2, wherein the reflection direction of each of the plurality of optical systems is a direction corresponding to differences in the thicknesses of each optical system's plurality of variable thickness elements.

4. The lighting apparatus of claim 1, wherein the light source module comprises a laser light source.

5. The lighting apparatus of claim 4, further comprising a light emitting module configured to diffuse the light output from the laser light source and reflected from the plurality of optical systems and to emit the diffused light outwardly.

6. The lighting apparatus of claim 5, wherein the controller is configured to determine a distribution of light emitted outwardly from the light emitting module by determining the reflection direction of each of the plurality of optical systems.

7. The lighting apparatus of claim 6, further comprising a sensor configured to sense at least one of an external object and an external light source and to generate a sensing signal,
wherein the controller is configured to determine the distribution of light emitted outwardly from the light emitting module according to the sensing signal.

8. The lighting apparatus of claim 7, wherein the controller is configured to determine the reflection direction of each of the plurality of optical systems such that the light emitted outwardly from the light emitting module has at least two main light distribution directions.

9. The lighting apparatus of claim 7, wherein the sensing signal includes information regarding a region in which at least one of the external object and the external light source is sensed, and the controller is configured to determine the reflection direction of each of the plurality of optical systems such that the light is not irradiated to the sensed region.

10. The lighting apparatus of claim 7, wherein the sensing signal includes information regarding a region in which at least one of the external object and the external light source is sensed, and the controller is configured to determine the reflection direction of each of the plurality of optical systems such that the light is irradiated to the sensed region.

11. The lighting apparatus of claim 4, wherein the light source module comprises a plurality of laser light sources outputting light having different colors.

12. The lighting apparatus of claim 11, wherein the light source module comprises a light collecting module configured to collect light having different colors and to generate white light.

13. The lighting apparatus of claim 12, wherein the light source module comprises an expander disposed between the light collecting module and the reflective module.

14. The lighting apparatus of claim 13, wherein the light source module comprises a collimator disposed between the expander and the reflective module.

15. A lighting apparatus comprising:
a light source module comprising a laser light source;
a reflective module comprising a plurality of optical systems each having a mirror configured to reflect light output from the light source module to a light emitting module;
a light emitting module configured to diffuse the light reflected from the plurality of optical systems and to emit diffused light outwardly; and
a controller configured to determine a reflection direction of each of the plurality of optical systems and to determine a distribution of the light emitted from the light emitting module.

16. The lighting apparatus of claim 1, wherein the variable thickness element comprises a piezoelectric element.

17. The lighting apparatus of claim 1, wherein the variable thickness element comprises a voice coil motor.

18. The lighting apparatus of claim 14, wherein the light source module comprises a reflector disposed between the collimator and the reflective module.
